(19) United States
(12) Patent Application Publication
(10) Pub. No.: US 2006/0290639 A1
(43) Pub. Date: Dec. 28, 2006

(54) Reduced swing differential signal transmission device for liquid crystal display

(75) Inventors: Yi-Chan Chen, Madou Township (TW); Wei-Chung Cheng, Niaosong Township (TW); San-Yueh Huang, Sigang Township (TW)

Correspondence Address: TROXELL LAW OFFICE PLLC, SUITE 1404, 5205 LEESBURG PIKE, FALLS CHURCH, VA, 22041, US

(73) Assignee: Elan Microelectronics Corp.

(21) Appl. No.: 11/358,058

(22) Filed: Feb. 22, 2006

(30) Foreign Application Priority Data
Jun. 24, 2005 (TW) 094121138

(51) Int. Cl. G09G 3/36

(52) U.S. Cl. 345/98

(57) ABSTRACT

The present invention is applied to a liquid crystal display (LCD) having a big size so that the LCD can be used with saved energy, small amplitude and low electromagnetic interference.

### FIELD OF THE INVENTION

The present invention relates to a transmission device; more particularly, relates to using a liquid crystal display (LCD) with saved energy, small amplitude and low electromagnetic interference (EMI).

### DESCRIPTION OF THE RELATED ART

A general source driver for a TFT-LCD (Thin-Film-Transistor Liquid Crystal Display) comprises parts with high voltage and parts with low voltage having the following characteristics:

(A) The power consumption by parts with high voltage mainly comes from operational amplifiers; and the power consumption depends on panel load. It will be possible for the parts with high voltage to save energy only if the panel can be driven with a small static current for running operational amplifiers.

(B) The power consumption for parts with low voltage mainly comes from the following two sources:

(1) dynamic current for logic circuit: The dynamic current for logic circuit counts on VDD volume and operational frequency.

(2) static current for RSDS transmission interface: An RSDS transmission interface requires ten high-speed comparators consuming a lot of energy, which contribute most of the energy consumption of the parts with low voltage.

How a conventional RSDS transmission interface can save energy depends on a basic operational principle for a source driver in an LCD panel. Please refer to FIG. 4, which is a block view showing a basic operational flow of a liquid crystal display (LCD) of a prior art. Take an XGA (extended Graphics Array, 1204×768) panel for example. An STB terminal 4 and eight 384-channel source drivers 41˜41g are required, where terminals 411, 411a˜411g of the source drivers 41˜41g for initial input pulses DIO1(1)˜DIO1(8) are connected with terminals 412, 412a˜412g of the source drivers 41˜41g for initial output pulses DIO2(1)˜DIO2(8). Display data for a whole line is serially passed from the first source driver 41 to the last source driver 41g one by one. When the system is going to transfer a line of data, a pulse will be sent to the terminal 411 of the first source driver 41 for initial input pulses DIO1(1) to inform the start of data transference. When the transference of the data required for the first source driver 41 is done, the terminal 412 for initial output pulse DIO2(1) will transfer a pulse to the terminal 411a of the second source driver 41a for initial input pulses DIO1(2) to inform the start of data transference to the second source driver 41a by the system. When the transference of the data required for the second source driver 41a is done, the terminal 412a for initial output pulse DIO2(2) will transfer a pulse to the terminal 411b of the third source driver 41b for initial input pulses DIO1(3) to inform the start of data transference to the third source driver 41b by the system. In the same way, data is transferred to the following source drivers 41c˜41g until all of the eight source drivers fetch the data required. And, then, the system will uniformly send a pulse to all source drivers 41˜41g so that all source drivers 41˜41g will transform fetched data into corresponding voltages to drive panel for displaying a line of display. The following lines is displayed in the same way.

Please further refer to FIG. 5, which is a block view showing a source driver of the prior art. For a common 6-bit source driver in an RSDS-transmitting LCD, the RSDS transmission interface requires ten high-speed comparators 5, 5a˜5i, where one comparator 5 is used for processing timing signals and the other nine comparators 5a˜5i are used for processing data signals. However, the operational frequency for the RSDS transmission interface is quite high (65 MHz˜100 MHz) so that the static power consumption for the comparators 5˜5i is quite high too. For further saving power consumption, two directions of solution can be considered: one is to reduce the static power consumed by each comparator 5˜5i to a lower level as possible; and the other one is to save non-critical power consumption at the system end.

The second solution is usually taken as a conventional way to save power consumption. As referring to the basic operational principle for an LCD panel, any source driver 41˜41g uses its RSDS transmission interface only when receiving data. So, a conventional way for saving energy is done by pausing comparators 5a˜5i which are not transferring data signals to stop consuming power; but timing signals continues running regardless of the pausing. Hence, during the time for displaying a line of data, any source driver 41˜41g can save ⅞ of the original power consumption; yet, the timing signals processed by a comparator in the RSDS transmission interface is the foundation for logic, so that, during the time for displaying a line of data, the comparator for processing timing signals for the source drivers 41˜41g never pause. And, because the operational frequency for the RSDS transmission interface is quite high (65 MHz˜100 MHz), it is quite hard to reduce the power consumed by the comparators. So, the prior art does not fulfill users' requests on actual use.

### SUMMARY OF THE INVENTION

Therefore, the main purpose of the present invention is to use an LCD, especially an LCD having a big size, with saved energy, small amplitude and low EMI.

To achieve the above purpose, the present invention is an RSDS transmission device for an LCD, comprising a first comparator for processing timing signals and adjusting timing delays between the timing signals and data signals according to a setup/hold time specification; and a plurality of second comparators of latch-type circuits for processing data signals, where the second comparators are connected with the first comparator to receive inner timing signals processed by the first comparator as control signals for timing signals of the second comparators.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is a block view showing a source driver according to a preferred embodiment of the present invention;

FIG. 2 is a view showing a circuit of a second comparator according to the preferred embodiment of the present invention;

FIG. 3 is a view showing a circuit of a first comparator according to the preferred embodiment of the present invention;

FIG. 4 is a block view showing a basic operational flow of a liquid crystal display (LCD) of a prior art; and

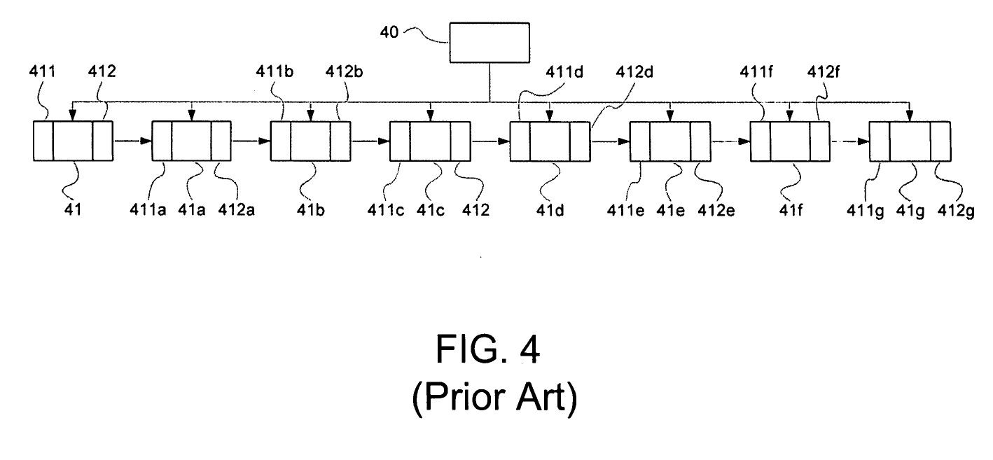

FIG. 5 is a block view showing a source driver of the prior art.

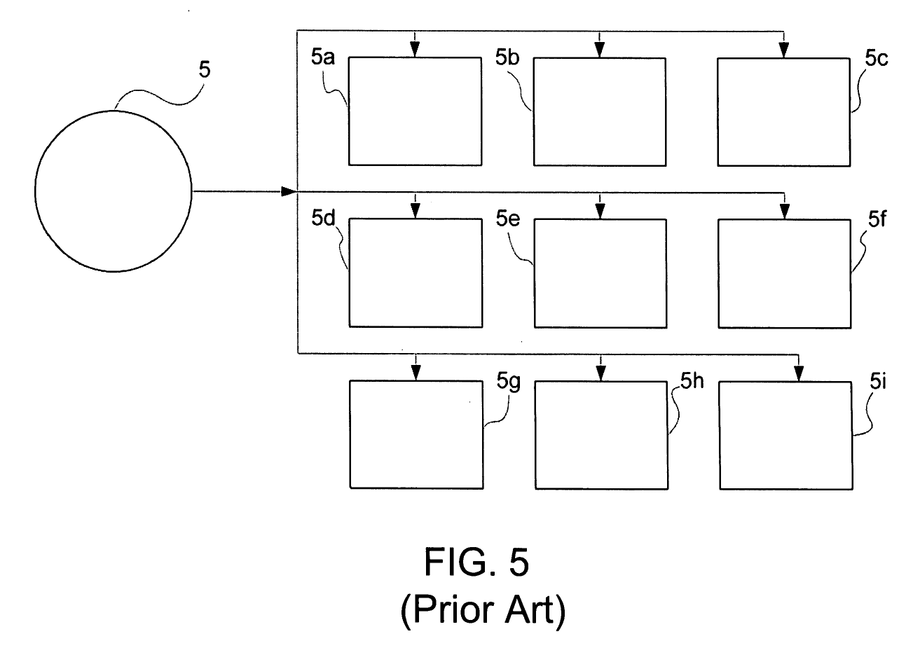

### DESCRIPTION OF THE PREFERRED EMBODIMENT

The following description of the preferred embodiment is provided to understand the features and the structures of the present invention.

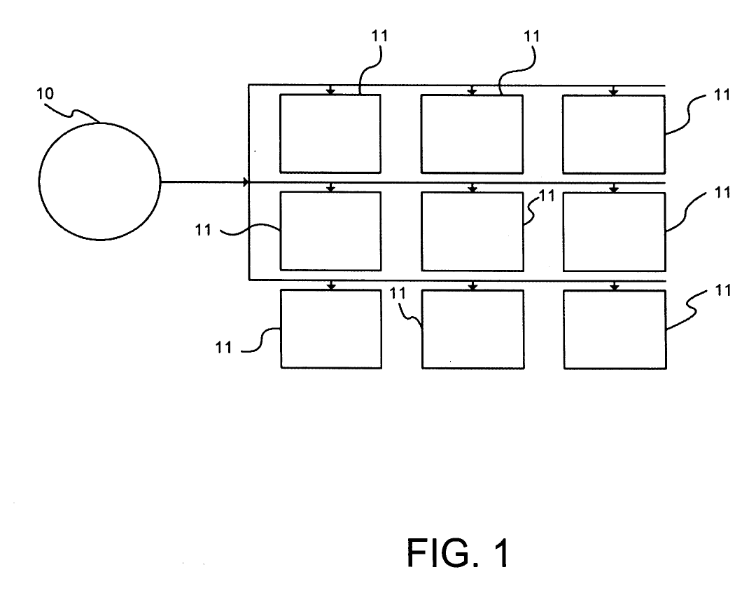

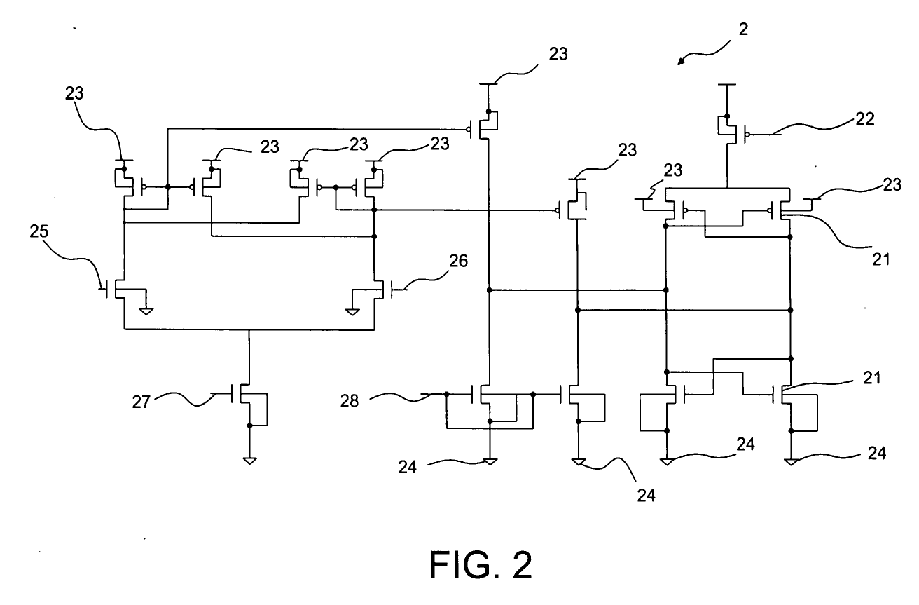

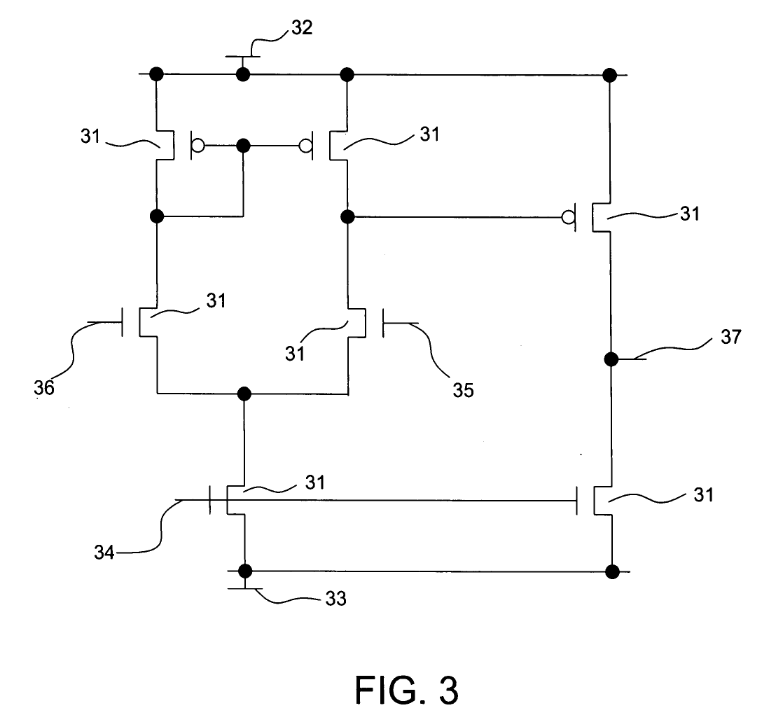

Please refer to FIG. 1, FIG. 2 and FIG. 3, which are a block view showing a source driver, a view showing a circuit of a second comparator and a view showing a circuit of a first comparator, according to a preferred embodiment of the present invention. As shown in the figures, the present invention is a reduced swing differential signal (RSDS) transmission device for an LCD, comprising a first comparator 10 and a plurality of second comparators 11, where the LCD can be used with saved energy, small amplitude and low electromagnetic interference (EMI).

The first comparator 10 processes timing signals and adjusts timing delays between timing signals and data signals according to a setup/hold time specification.

Each second comparator 11 is a latch-type circuit, comprising a plurality of transistors 21, a timing terminal 22, a plurality of first voltage terminals 23, a plurality of second voltage terminals 24, a first input 25, a second input 26, a first bias terminal 27 and a second bias terminal 28, which processes data signals and is connected with the first comparator to receive inner timing signals processed and outputted by the first comparator as control signals for timing signals of the second comparators 11. Therein, the transistor 21 comprises a basic structure of a BJT (Bipolar Junction Transistor) transistor, a FET (Field-Effect Transistor) transistor, a MOS (Metal-Oxide Semiconductor) transistor or a CMOS (Complementary Metal-Oxide Semiconductor) transistor. According to an actual circuit requirement, such as a requirement of matching, capacitances, resistances, diodes or other transistors can be connected between the transistors 21 in a serial or a parallel way. Hence, a novel RSDS transmission device for an LCD is obtained.

The present invention provides a first comparator 10 of a un-latch-type circuit coordinated with nine second comparators 11 of latch-type circuits to save energy in an RSDS interface (as shown in FIG. 1). Regarding the first comparator 10 and the second comparator 11 in the RSDS interface, the first comparator 10, which is faster (and also more power-consuming) than the second comparator 11, is used to process timing signals. A preferred embodiment of the first comparator 10 is shown in FIG. 3, comprising a plurality of transistors 31, a VDD terminal 32, a VSS terminal 33, a bias terminal 34, a first input 35, a second input 36 and an output terminal 37, which adjusts timing delays between the timing signals and the data signals according to the setup/hold time specification. The nine second comparators 11 is used to process data signals coordinately while using the inner timing signals processed by the first comparator 10 as timing control signals. Consequently, although the first comparator 10 for processing timing signals consumes one to two times of power more than a conventional comparator does, total power consumption is much lower than a general one owing to the nine second comparators 11 of latch-type circuits with extremely low power consumption.

To sum up, the present invention is an RSDS transmission device for an LCD, where the LCD is used with saved energy small amplitude and low EMI.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A reduced swing differential signal (RSDS) transmission device for a liquid crystal display (LCD) comprising:
(a) a first comparator processing timing signals, said first comparator adjusting timing delays between said timing signals and data signals according to a setup/hold time specification; and
b) a plurality of second comparators of latch-type circuits processing data signals, said second comparators connecting with said first comparator to receive inner timing signals processed and outputted by said first comparator to be control signals to timing signals of said second comparators.

2. The transmission device according to claim 1, where in said latch-type circuit comprises a plurality of transistors.

3. The transmission device according to claim 2, wherein said transistor is connected in a serial way to a component selected from a group consisting of a resistance, a diode, a capacitance and another transistor.

4. The transmission device according to claim 2, where in said transistor is connected in a parallel way to a component selected from a group consisting of a resistance, a diode, a capacitance and another transistor.

5. The transmission device according to claim 2, wherein said transistor comprises a basic structure of a BJT (Bipolar Junction Transistor) transistor.

6. The transmission device according to claim 2, wherein said transistor comprises a basic structure of a FET (Field-Effect Transistor) transistor.

7. The transmission device according to claim 2, where in said transistor comprises a basic structure of a MOS (Metal-Oxide Semiconductor) transistor.

8. The transmission device according to claim 2, wherein said transistor comprises a basic structure of a CMOS (Complementary Metal-Oxide Semiconductor) transistor.
